(19) United States
(12) Patent Application Publication
(10) Pub. No.: US 2026/0063154 A1
(43) Pub. Date: Mar. 5, 2026

(54) BAND CLAMP WITH MOVABLE FASTENER

(71) Applicant: Band-It-IDEX, Inc., Denver, CO (US)

(72) Inventors: Kevin Wagner, Denver, CO (US); Bai Kiet Tran, Westminster, CO (US); Geoffrey Alan Swanson, Monument, CO (US); Gary Wells, Leicestershire (GB); Jens Sturies, Wettstetten (DE)

(21) Appl. No.: 19/313,467

(22) Filed: Aug. 28, 2025

Related U.S. Application Data
(60) Provisional application No. 63/688,442, filed on Aug. 29, 2024.

(51) Int. Cl. F16B 2/08; B60R 21/26

(52) U.S. Cl. CPC F16B 2/08; B60R 21/26

(57) ABSTRACT

A clip for use with a band clamp for securing one object to another object includes a generally U-shaped body defining a slot between an inner plate and outer plate where the slot is configured to receive the band of the band clamp. A fastener extends from the outer plate of the clip. When the band is formed into a closed loop but not yet fully tensioned about a first object, the clip is movable along the circumference of the closed loop. such that, the fastener may be accurately relocated as needed to align with a complimentary structure associated with a second object that receives the fastener. The band clamp may then be fully secured and locked to the first object allowing the two objects to be secured to each other.

### CROSS-REFERENCE TO RELATED APPLICATIONS

This U.S. Non-Provisional Patent Application claims benefit of U.S. Provisional Application No. 63/688,442 filed on Aug. 29, 2024 entitled “BAND CLAMP WITH MOVABLE FASTENER,” the entire disclosure of which is incorporated herein by reference in its entirety.

### FIELD

Embodiments of the present disclosure are generally related to a band clamp with a fastener or post whose position is adjustable or moveable relative to the band. The fastener or post is intended to connect the band clamp to a separate structure.

### BACKGROUND

Band clamps are widely used in a variety of situations. For example, one common usage is to install and secure airbags and airbag inflators in vehicles. Such band clamps may include a closed loop or ring formed and defined by a band, where the band is secured to an airbag inflater or side curtain and the combination is then secured to a vehicle fixture, such as a seat or door frame. Airbags have been required in vehicles since at least 1998. To this end, conventional band clamps may also be equipped with a fixed post fastener that connects the band of the band clamp to a complimentary structure on the frame of the vehicle. The inflator is secured in position by using the fastener associated with the band clamp. During installation of the airbag inflator to the frame of a vehicle, one or more bands are secured to the body of the inflator. Typically, an installation tool grips the free end of the band while holding the buckle in a fixed position. The tool pulls the band, reducing its diameter about the inflator until the inflator is tightly held by the band. The band is then secured by a buckle to lock the band to the inflator. Any excess length of the band is cut off and removed. In a subsequent step, a fixed fastener associated with each band is secured to a complementary structure or connector on a frame or other structure of a vehicle thereby securing the inflator to the vehicle. Thus, when the band clamp is secured to the inflator, the location of the fixed fastener must be correct in order for the fastener to be aligned with the complementary structure. In addition, because of restricted and limited space within the door frame or seat frame, the location of the buckle, e.g., an ear clamp, which is now also fixed in position relative to the inflator, can interfere with the surrounding frame when a technician attempts to install the inflator in the vehicle. The interference can cause non-alignment between the fastener and the complimentary connector mounted to the frame.

Airbags and inflators are manufactured in varied sizes because vehicles are made in varied sizes and shapes. Although it is generally known by the operator where to install the one or more band clamps on the inflator body with respect to each different vehicle and each different inflator, incorrect or poor placement of the band clamp can preclude subsequent connection of the inflator to the vehicle frame. If the relative position of the fastener is not correct and the fastener does not align with the complimentary connector or securement feature on the vehicle fixture, one or more of the band clamps must be removed from the inflator and discarded and new band clamps installed. This slows the installation process, which is often part of a moving assembly line, and wastes band clamps.

To streamline and accelerate the highly repetitive airbag inflator installation process on a vehicle assembly line, vehicle manufacturers often order customized band clamps for different vehicle models with different airbag configurations. This reduces the possibility of misalignment when the inflator is connected to the vehicle frame. For example, some band clamp manufacturers have designed band clamps where the fixed post fastener is offset from the band to satisfy alignment requirements relative to a specific vehicle frame. However, customization requirements to accommodate installation configurations and inflator variations significantly increase the manufacturing cost and inventory storage pressure for vehicle manufacturers.

Thus, there has been a long felt and unresolved need in the art for a band clamp with an adjustable or movable fastener that can accommodate various installation environments.

### SUMMARY

It is an aspect of the present disclosure to provide more flexibility in airbag installation with fewer band clamp varieties. To this end, embodiments of the present disclosure comprise a movable clip attached to the band of a band clamp. A fastener is attached to or associated with the clip and the fastener then is used to attach the band clamp to a permanent structure, such as the frame of a vehicle seat or door. The clip may comprise an aperture configured to securely receive the fastener, or the fastener may be affixed to the clip by welding, swaging or other securement methods. Alternatively, the aperture may be threaded to receive a threaded fastener. The aperture may be circular or any other shape to mate with a complementary shaped post or fastener.

In all embodiments of the present disclosure, the clip is movable along the band of a band clamp to add flexibility to the installation process, for example, to meet different installation conditions. Specifically, when attached to the band, the clip is movable along the longitudinal axis or length of the band so that the location of the clip and buckle may be repositioned relative to each other. The repositionable clip may be used with any type or style of band clamp that is formed into a closed loop, e.g., center punch clamps (as illustrated in the exemplary figures herein), pinch and ear clamps, spring band clamps, constant tension clamps, quick release clamps, V-band clamps, t-bolt clamps and worm gear clamps. Thus, when the band is formed in a closed loop, for example in a non-limiting embodiment of a center punch clamp when one end of a band is threaded through a buckle and a closed loop is formed, the clip may be repositioned around the closed loop while the buckle remains stationary. Similarly, in other types or styles of clamps, where there is no need to form a closed loop by threading one end of a band through a buckle or other locking mechanism, the clip also may be repositioned around the closed loop while the locking mechanism remains stationary.

In the specific case of inflators, an installer knows where the fastener must be positioned relative to the inflator after the band clamp is tightly cinched and then secured to the inflator in order for the fastener to align with a complementary fastener or connector on the vehicle frame and the inflator to be correctly positioned for inflation of an airbag in the event of an accident. Indeed, the installer may have a separate installation fixture for each different inflator and each different vehicle frame configuration that identifies the precise location of where the fastener must be after the band is secured to the inflator.

Regardless of the type or style of band clamp, embodiments of the present invention allow the installer or technician to locate the band locking mechanism relative to the location of the installation tool, allowing the tool to tighten and secure the band around the inflator and further allow the location of the clip to be moved around the band to a correct or desired location before the band is tightened and secured. With the added flexibility afforded by band clamps of the present disclosure, fewer custom mounting brackets are needed.

Furthermore, according to embodiments of the present disclosure, the fasteners may be constructed in varied sizes and lengths, including but not limited to, M5 and M6 bolts, threaded posts, threaded fasteners, and unthreaded posts and fasteners. In embodiments where the fastener is threaded, the fastener may be threaded into, for example, a frame of a vehicle. In embodiments where the fastener is not threaded, the fastener may be fixed to the frame by, for example, a press fit, welding, swaging, adhesion, or the like. In some embodiments the fastener may be a self-clinching stud.

According to the present disclosure, the clip may comprise a U-shaped body having an inner plate and an outer plate with a gap or slot between the two plates to receive the band. In some embodiments, an aperture is formed in the outer plate, directly opposite the inner plate. In some embodiments, the outer plate is differently sized compared to the inner plate and includes an extended area. For example, the extended area may be oriented coaxially with the longitudinal axis of the band or laterally offset relative to the longitudinal axis of the band or any location between those two positions. In addition, the size and shape of the extended area may also vary to meet installation needs. As a result, the fastener may be offset relative to the location of the inner plate to provide additional flexibility for installation purposes.

In some embodiments, the fastener and clips are manufactured in stainless steel and the band is made from carbon steel.

In some embodiments, the fastener may be made from carbon steel and the clip from a steel or steel alloy that is harder than carbon steel.

In some embodiments, a clamping system according to the present disclosure may include an elongate band having a first end and a second end, a buckle affixed to the band proximate the first end, the buckle including an opening therethrough for receiving the second end of the band, a clip secured to the band and movable along the length of the band relative to the buckle, and a fastener secured to the clip.

In some embodiments, a clamping system according to the present disclosure may include a clip having an inner plate, an outer plate spaced from the inner plate and defining a slot between the inner plate and outer plate, and wherein the band is positioned in the slot.

In some embodiments, a clamping system according to the present disclosure may include an inner plate with an inner surface that has a beveled area to facilitate attaching the clip to a band.

In some embodiments, a clamping system according to the present disclosure may include a fastener that has a longitudinal axis that, when a clip containing the fastener is attached to a band, the longitudinal axis of the fastener would extend through the band, nonlimiting examples of which are illustrated in FIGS. 1 and 8.

In embodiments according to the present disclosure the band is configured to form a closed loop having a diameter, and where the longitudinal axis of the fastener is coaxial with the diameter and in other embodiments the longitudinal axis of the fastener is not coaxial with the diameter, nonlimiting examples of which are illustrated in FIGS. 8 and 1, respectively.

In some embodiments, a clamping system according to the present disclosure may include a clip with an inner plate that has a first surface area and an outer plate has a second surface area that is larger than the first surface area of the inner plate, a fastener with a first end and a second end defining a longitudinal axis of the fastener, and the fastener is affixed to the outer plate at a position where the longitudinal axis of the fastener would not extend through the first surface area of the inner plate, nonlimiting examples of which are illustrated in FIGS. 1 and 6.

In some embodiments, a clamping system according to the present disclosure may include a band having a first side edge and a second side edge defining a width of the band, and the longitudinal axis of the fastener would not extend through the band between the first and second side edges, nonlimiting examples of which are illustrated in FIG. 6.

In some embodiments, a clamping system according to the present disclosure may include a clip with an outer plate having an extended area oriented perpendicular to the longitudinal axis of the band, nonlimiting examples of which are illustrated in FIG. 6.

In some embodiments, a clamping system according to the present disclosure may include a clip with an outer plate having an extended area oriented perpendicular to a longitudinal axis of the band when the clip is attached to the band nonlimiting examples of which are illustrated in FIG. 6.

In some embodiments, a clamping system according to the present disclosure may include a clip with an outer plate having an extended area oriented parallel to a longitudinal axis of the band when the clip is attached to the band, nonlimiting examples of which are illustrated in FIG. 1.

In some embodiments, a clamping system according to the present disclosure may include a fastener constructed of 300 series stainless steel or where the fastener is an M5 or M6 threaded fastener.

In some embodiments, a clamping system according to the present disclosure may include a clip constructed from 200 series or 300 series stainless steel.

It is another aspect of the present disclosure to provide an improved method for attaching a fastener to a clip. The material comprising the clip body is initially flat or planar with a first side and a second side. The method comprises a first step of forming a hole or aperture in a portion of the body of the clip. The aperture extends through the entirety of the body of the clip from the first side to the second side. In a second step, an outwardly extending tapered lip is formed around the perimeter of the aperture on the second side of the clip body. In a third step, a post or stud, such as a self-clinching stud, is placed in the aperture such that the head of the stud is flush with the surface of the first side of the clip body. In a fourth step, the outwardly extending tapered lip is deformed about the stud in order to secure the stud to the clip body. Steps one, two and four may be accomplished with a progressive die. Following securement of the fastener to the clip, the clip body may be reconfigured, for example, into a U-shape, with the fastener attached to the outer plate of the clip. The clip may be formed into any shape configured to attach to and be repositionable relative to a band.

It is another aspect of the present disclosure to provide a rigid yet light-weighted and compact clamp for securing a first object to a second object. In one example, the first object is an airbag inflator, and the second object is a vehicle. Embodiments according to the present disclosure may be used with other objects.

In some embodiments, traditional “ear clamps” used to secure the first test object to the second in a fixed position may be eliminated.

The ability to change the position of the fastener also allows the band clamp to be used in other locations within a vehicle for securing other components, in addition to airbag inflators, and in applications beyond vehicles including banding objects to other structures, such as lamp posts, street signage posts, oil drilling structures and other structures.

While specific embodiments and applications have been illustrated and described, the present disclosure is not limited to the precise configuration and components described herein. Various modifications, changes, and variations which will be apparent to those skilled in the art may be made in the arrangement, operation, and details of the methods and systems disclosed herein without departing from the spirit and scope of the overall disclosure.

As used herein, unless otherwise specified, the terms “about,” “approximately,” etc., when used in relation to numerical limitations or ranges, mean that the recited limitation or range may vary by up to 10%. By way of non-limiting example, “about 750” can mean as little as 675 or as much as 825, or any value therebetween. When used in relation to ratios or relationships between two or more numerical limitations or ranges, the terms “about,” “approximately,” etc. mean that each of the limitations or ranges may vary by up to 10%; by way of non-limiting example, a statement that two quantities are “approximately equal” can mean that a ratio between the two quantities is as little as 0.9:1.1 or as much as 1.1:0.9 (or any value therebetween), and a statement that a four-way ratio is “about 5:3:1:1” can mean that the first number in the ratio can be any value of at least 4.5 and no more than 5.5, the second number in the ratio can be any value of at least 2.7 and no more than 3.3, and so on.

The embodiments, configurations and examples described herein are not exhaustive. As will be appreciated, other embodiments are possible utilizing, alone or in combination, one or more of the features set forth above or described in detail below, particularly as will be understood by those of skill in the art following review of the present disclosure.

The details of one or more aspects of the disclosure are set forth in the accompanying drawings and the description below. Other features, objects, and advantages of the techniques described in this disclosure will be apparent from the description and drawings, and from the claims.

The phrases “at least one”, “one or more”, and “and/or” are open-ended expressions that are both conjunctive and disjunctive in operation. For example, each of the expressions “at least one of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together. When each one of A, B, and C in the above expressions refers to an element, such as X, Y, and Z, or class of elements, such as X1-Xn, Y1-Ym, and Z1-Zo, the phrase is intended to refer to a single element selected from X, Y, and Z, a combination of elements selected from the same class (e.g., X1 and X2) as well as a combination of elements selected from two or more classes (e.g., Y1 and Zo).

The term “a” or “an” entity refers to one or more of that entity. As such, the terms “a” (or “an”), “one or more” and “at least one” can be used interchangeably herein. It is also to be noted that the terms “comprising”, “including”, and “having” can be used interchangeably.

The preceding is a simplified summary of the disclosure to provide an understanding of some aspects of the disclosure. This summary is neither an extensive nor exhaustive overview of the disclosure and its various aspects, embodiments, and configurations. As will be appreciated, other aspects, embodiments, and configurations of the disclosure are possible utilizing, alone or in combination, one or more of the features set forth above or described in detail below.

Numerous additional features and advantages of the present disclosure will become apparent to those skilled in the art upon consideration of the embodiment descriptions provided hereinbelow.

### BRIEF DESCRIPTION OF THE DRAWINGS

The accompanying drawings which are incorporated in and constitute a part of the specification, illustrate embodiments of the disclosure and together with a general description of the disclosure given above and the detailed description of the drawings given below, serve to explain the principles of disclosure.

FIG. 1 is a perspective view of a band clamp with a clip of one embodiment of the present disclosure;

FIG. 2 is a second perspective view of a band clamp with a clip of the embodiment of FIG. 1;

FIG. 3 is a side view of the band clamp with a clip of the embodiment of FIG. 1;

FIG. 4 is a perspective view of the clip of the embodiment of FIGS. 1-3.

FIG. 5A is a perspective view of the clip of FIG. 4, without a fastener attached.

FIG. 5B is a bottom view of the clip of FIG. 5A.

FIG. 5C is a top view of the clip of FIG. 5A, prior to forming.

FIG. 6 is a perspective view of a band clamp with another embodiment of a clip according to the present disclosure.

FIG. 7A is a top view of the clip of FIG. 6, prior to forming.

FIG. 7B is a perspective view of the clip of FIG. 6, without a fastener.

FIG. 7C is a top view of the clip of FIG. 7B.

FIG. 7D is a bottom view of the clip of FIG. 7B.

FIG. 8 is a perspective view of a band clamp with another embodiment of a clip according to the present disclosure.

FIG. 9 is a second perspective view of the band clamp and clip of FIG. 8.

FIG. 10A is a top view of the clip of FIG. 8, without a fastener.

FIG. 10B is a perspective bottom view of the clip of FIG. 10A.

FIG. 10C is a bottom view of the clip of FIG. 10A.

FIG. 10D is a perspective bottom view of the clip of FIG. 10A.

FIG. 11 is another perspective view the band clamp and clip of FIG. 8.

FIG. 12 is an enlarged perspective view of the clip of FIG. 11.

FIG. 13 is a side view of the band clamp and clip of FIG. 11.

FIG. 14 is a flow chart illustrating an embodiment of a method of manufacturing a band clamp according to the present disclosure.

FIG. 15 is a cross-section front view of a first tool and die and plate, following a first punch operation;

FIG. 16 is a cross-section front view of a second tool and die and the plate of FIG. 15, following a second punch operation;

FIG. 17 is cross-section front view of a third tool and die, the plate of FIG. 15 and a fastener, prior to a third punch operation;

FIG. 17A is an enlarged partial cross-section of the fastener of FIG. 17;

FIG. 17B is an enlarged partial cross-section of the die of FIG. 17, with the fastener removed;

FIG. 18 is a cross-section front view of the plate and fastener of FIG. 17 following a third punch operation;

FIG. 18A is an enlarged partial cross-section of the plate and fastener of FIG. 18;

FIG. 19 is a flow chart illustrating an embodiment of a method of manufacturing a band clamp according to the present disclosure.

While the following disclosure describes the disclosure in connection with those embodiments presented, one should understand that the disclosure is not strictly limited to these embodiments. Furthermore, one should understand that the drawings are not necessarily to scale, and that in certain instances, the disclosure may not include details which are not necessary for an understanding of the present disclosure, such as conventional details of fabrication and assembly.

### DETAILED DESCRIPTION

The Detailed Description is to be construed as exemplary only and does not describe every possible embodiment or installation method since describing every possible embodiment of the support device or method of using the device would be impractical, if not impossible. Numerous alternative embodiments could be implemented, using either current technology or technology developed after the filing date of this patent, which would still fall within the scope of the claims. Additionally, any combination of features shown in the various figures can be used to create additional embodiments of the present disclosure. Thus, dimensions, aspects, and features of one embodiment of the support device can be combined with dimensions, aspects, and features of another embodiment of the support device to create the claimed embodiment.

Unless defined otherwise, all technical and scientific terms used herein have the same meaning as is commonly understood by one of ordinary skill in the art. All patents, applications, published applications, and other publications to which reference is made herein are incorporated by reference in their entirety. If there is a plurality of definitions for a term herein, the definition provided in the Summary prevails unless otherwise stated.

Before any embodiments of the disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

A number of variations and modifications of the foregoing disclosure can be used. It would be possible to provide for some features of the disclosure without providing others.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

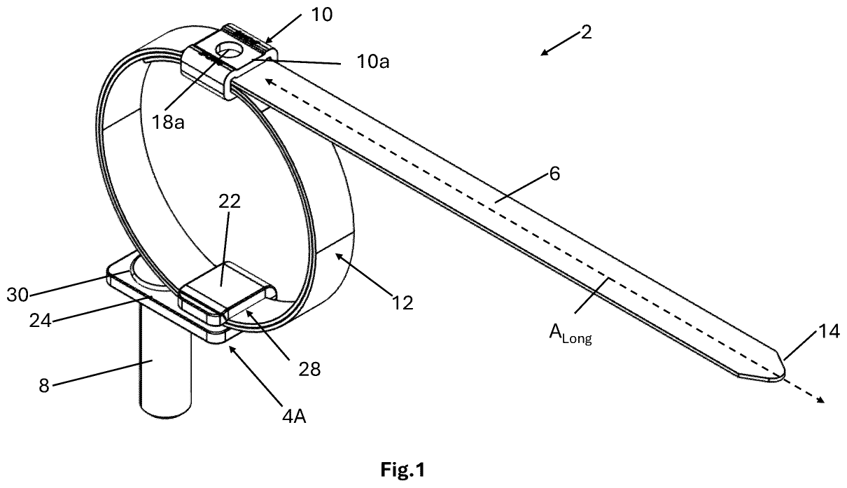

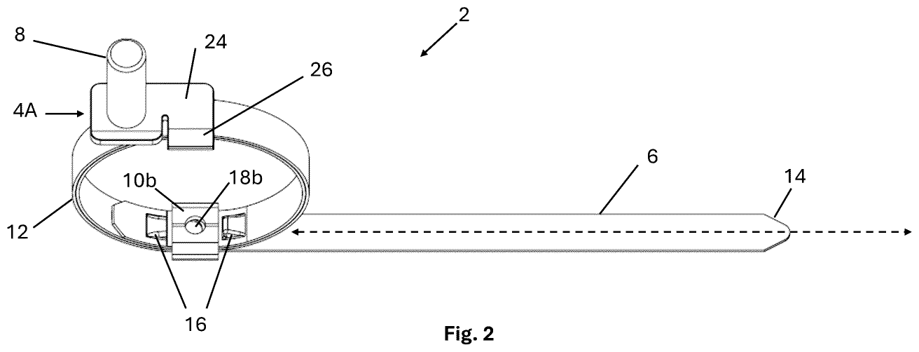

FIGS. 1-3 illustrate one nonlimiting embodiment of a band clamp 2 comprising a clip 4A, a band 6, a fastener 8 and a locking mechanism 10. Here the illustrated locking mechanism is a buckle secured with a punch but may be any time of locking member or locking mechanism depending upon the type of band clamp used. In this illustration, the band 6 forms a closed loop or ring 12 by passing the free end 14 through a buckle 10. The band 6 may be, for example, bent or curled to form the closed loop 12. With other types and styles of band clamps, the band may be preformed into a closed loop as is the case with pinch and ear clamps, spring band clamps, constant tension clamps, quick release clamps, V-band clamps, t-bolt clamps and worm gear clamps. In the illustrated embodiment, the buckle 10 may be attached to the band 6 such that the buckle 10 is freely movable along the length or longitudinal axis A_{long band} of the band 6. Alternatively, the buckle 10 may be held in position using, for example, two deformations 16 formed on a common side of the band 6 and spaced apart to restrain movement of the buckle 10 relative to the band 6 as shown in U.S. Pat. No. 5,483,998 and U.S. Pat. No. 8,424,166, of which both the entire disclosures are incorporated by reference herein. In other embodiments, the band 6 may not include the deformations 16. For example, the buckle 10 may be fixed to the band 6 by, for example, being welded, swaged or crimped to the band 6. The buckle 10 further includes an aperture 18a in its outer section 10a (FIG. 1) and a second aperture 18b in its inner section 10b (FIG. 2) that permits a punch associated with an installation tool (not shown) to travel through the aperture 18a and deform the underlying band such that a portion of the band extends into aperture 18b thereby locking the buckle relative to the band to prevent movement of one relative to the other. In yet other embodiments, depending upon the type or style of the band clamp, the locking mechanism may be integral with the band.

Continuing with the exemplary embodiment of a center punch band clamp, as part of the installation process, the loop 12 is tensioned about an inflator by an installation tool, which then drives a punch into the band 6 thereby locking the circumference of the band relative to the buckle 10 and securing the band clamp 2 to the inflator. The tool then removes any excess band extending from the buckle, An example of such a tool is shown and described in U.S. Pat. No. 5,483,998, the entirety of which is incorporated by reference herein. Alternatively, as will be understood by those of skill in the art, the buckle may secure the band with other known methods and structures, including with a lip lock, rather than a punch.

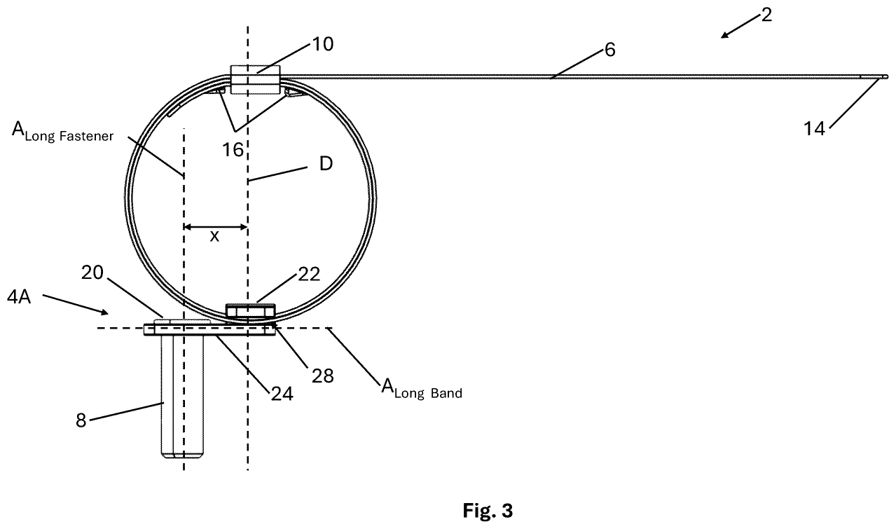

As illustrated in FIG. 3, the closed loop 12 formed by the band 6 has a diameter D that passes through the clip 4a and the buckle 10. In this embodiment, the fastener 8 is longitudinally offset from the diameter D by a distance “x” measured between the diameter D and the longitudinal axis A_{Long Fastener} of the fastener. The fastener head 20 is visible. The length of the offset x can vary to accommodate different installation conditions. The longitudinal axis of the band A_{Long Band} is projected onto the clip 4A.

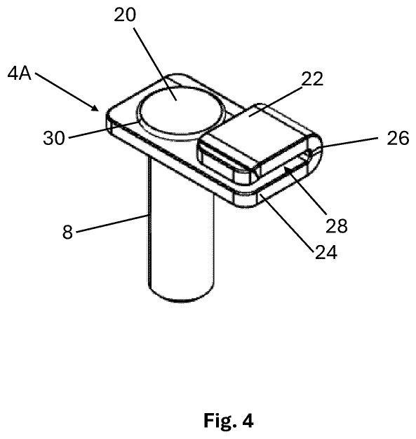

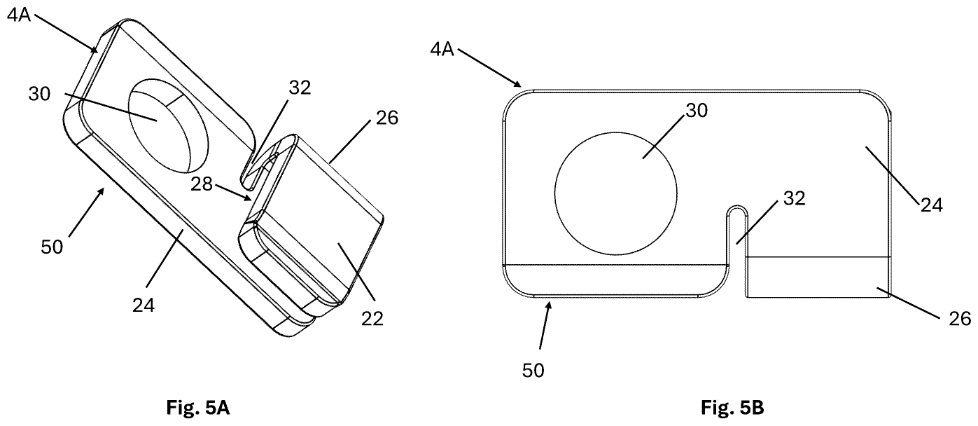

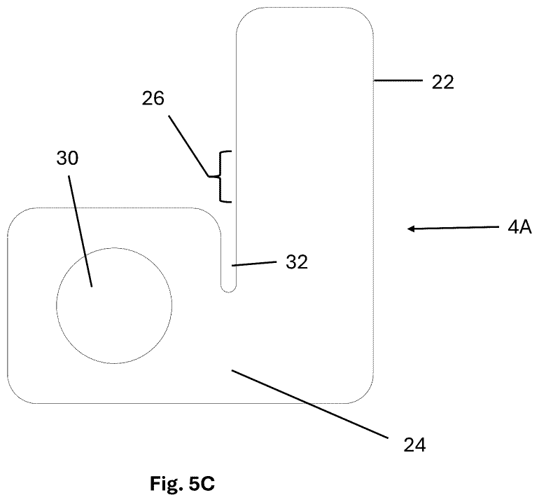

FIGS. 4 and 5A-5C further illustrate clip 4A. The clip 4A has an inner plate 22 and an outer plate 24 interconnected by an end wall 26. The terms inner and outer are used in reference to an installed band 6. More particularly, the inner plate 22 is positioned along the inner surface of the band, namely, the surface of the band 6 that would contact the outer surface of an airbag inflator when the band is wrapped about the inflator to form a closed loop. The outer plate 24 is positioned along the outer surface of band 6, namely, the band surface opposite the inner surface and which does not contact the inflator when installed. As illustrated, in its final form the clip 4A is U-shaped with an opening or slot 28 between the inner plate 22 and the outer plate 24 to receive the band 6. As a result of the space 28, the clip 4A may be moved along the length of the band 6 or around a circumference of the band 6 after the band is formed into a closed loop.

FIGS. 5A-C provide more detailed views of the clip 4A but without a fastener. The outer plate 24 further comprises an aperture 30 (as shown in FIG. 5A) for receiving a fastener 8. The fastener 8 may be secured to the clip 4A by, for example, welding, swaging or by a threaded engagement, or by other methods known by those of skill in the art for interconnecting metal pieces. The fastener may be, for example, M5 and M6 threaded fasteners, a threaded stud, an unthreaded post, or any other fastener configured to secure the band 6 (and thus, the airbag inflator). The aperture 30 would include complimentary threads if the fastener is threaded.

As illustrated in FIG. 5C, the clip 4A may be manufactured from a single piece of material, for example, by stamping an initial rectangular shape from metal sheet and then bending a portion of the sheet into a U-shape. The single sheet may include a slot 32 to facilitate bending to form the end wall 26 of the clip 4A. However, in some end use situations where strength requirements are reduced, the clip may be constructed from multiple metal pieces and combined through, for example, welding or swaging. In other end uses, the clip may be made from plastic or other materials using, for example, additive manufacturing.

As best illustrated in FIG. 5A, the outer plate 24 is larger than the inner plate 22, to include an extended area 50. The extended area moves the location of the aperture 30 coaxially along the longitudinal axis A_{long band} of the band 6 to a position offset or unaligned with the inner plate 22. The length of the offset along the longitudinal axis of the band may be changed to meet the specific installation requirements. As discussed below in connection with other embodiments, the extended area may also position the fastener laterally or angularly offset from the band longitudinal axis A_{long}.

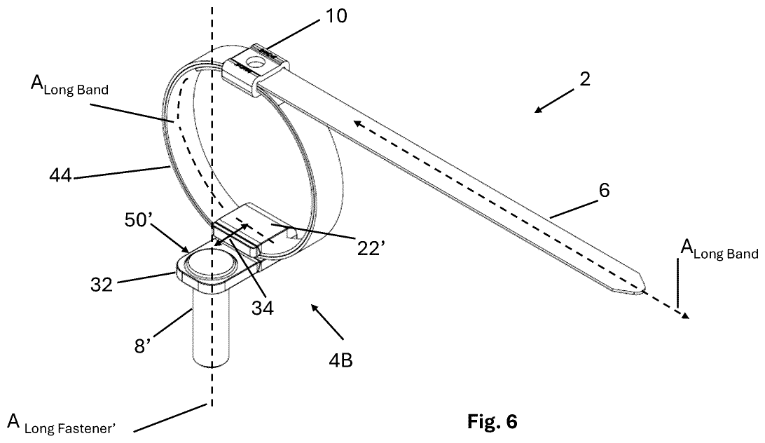

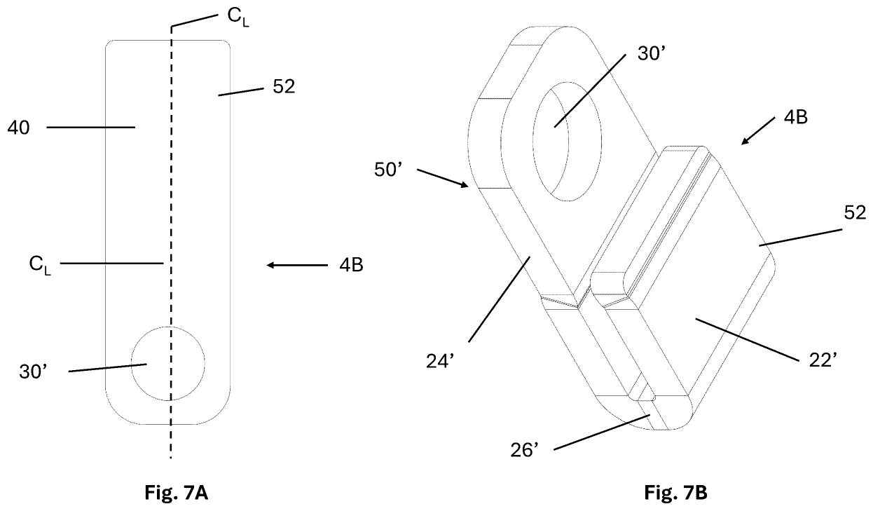

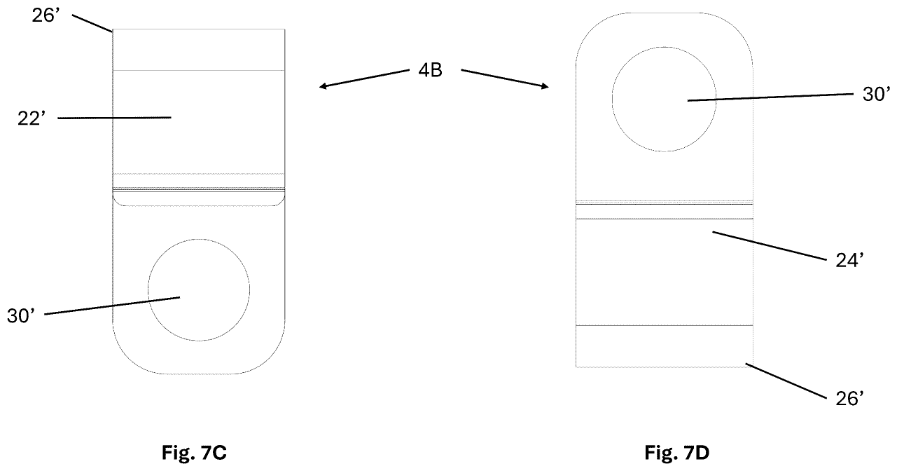

FIGS. 6-7D illustrate another embodiment of a clip 4B. The clip 4B comprises an inner plate 22′ and an outer plate 24′ joined by an end wall 26′. An aperture 30′ is configured to receive a fastener 8′. The clip 4B may be manufactured from a rectangular metal sheet 40, shown in FIG. 7A, by folding one end 52 of the metal sheet back on itself, specifically, along the longitudinal central line C_{L} of the metal sheet.

As discussed above with respect to clip 4A, the fastener 8′ of this embodiment may also be attached and/or fixed to the clip by a threaded engagement or by alternative attachment methods, for example, the fastener may be welded to the clip or be constructed as one-piece component. Furthermore, the fasteners and the clip can be constructed in same or different materials.

In the present embodiment, the fastener 8′ is laterally offset from the longitudinal axis A_{long band} of the band 6. As shown in FIG. 7B, the outer plate 24′ has an extended area 50′ that locates the fastener 8′ laterally offset from the longitudinal axis of band 6. As illustrated in FIG. 6 by the arrow 34, the longitudinal axis 20′ of the fastener 8′ is laterally offset from the longitudinal axis A_{long} of the band to accommodate the location of complimentary connectors associated with a vehicle frame that are laterally offset from the fixed location of the band, once the band is secured to the inflator.

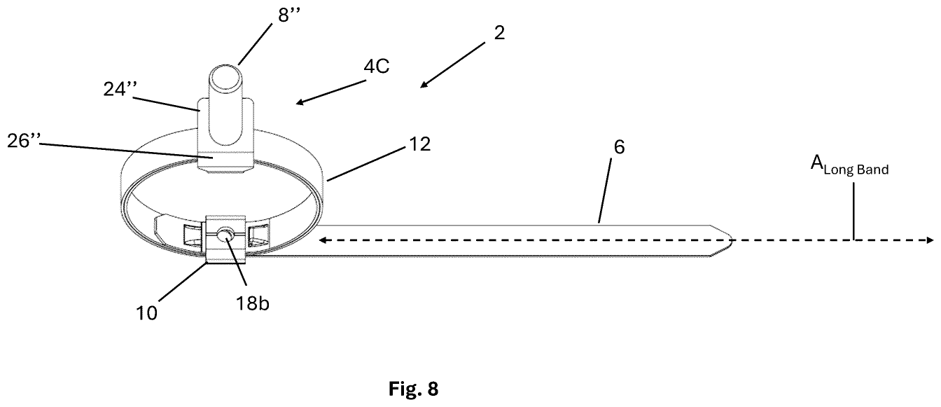

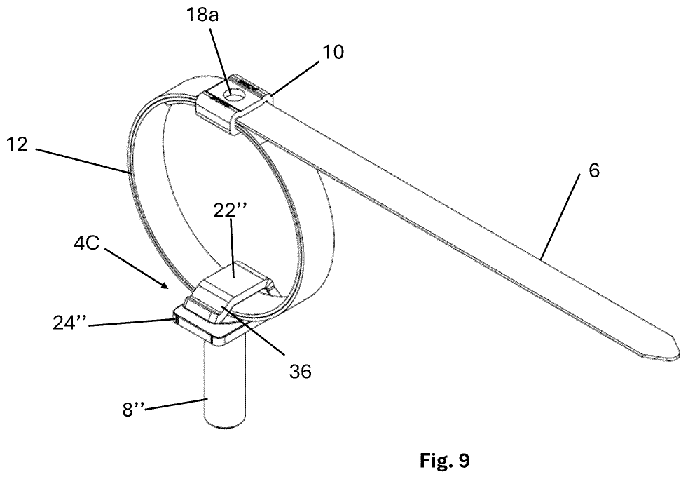

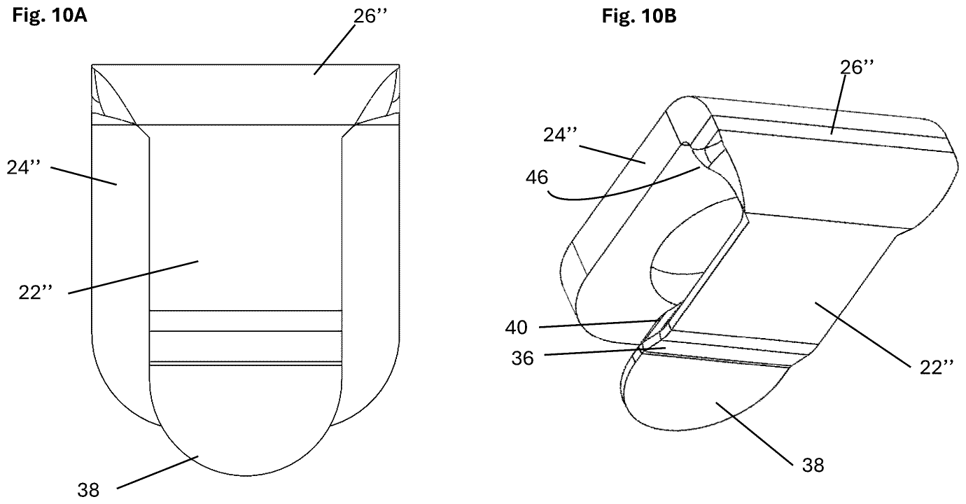

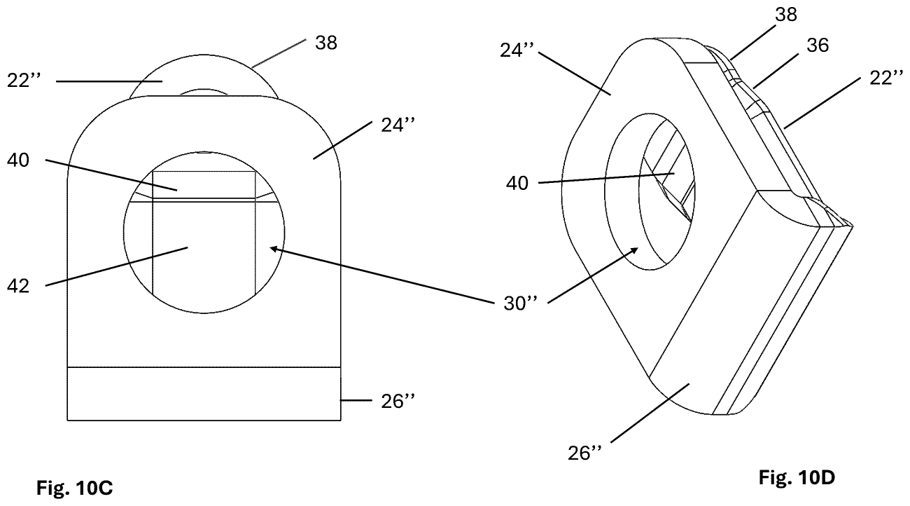

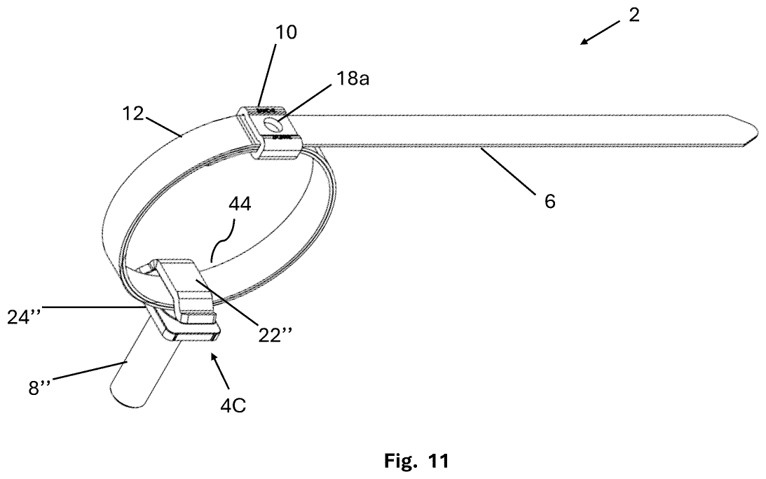

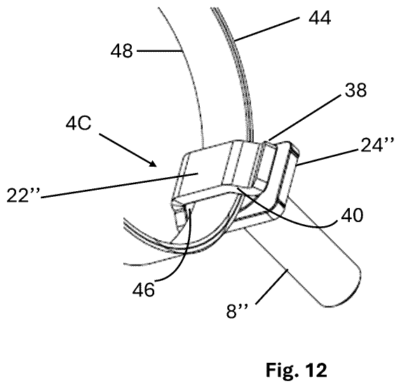

A third embodiment of a clip 4C is illustrated in FIGS. 8-14. Here, the fastener 8'′ is not longitudinally or laterally offset but rather extends outwardly directly from the longitudinal axis A_{long} of the band 6. With reference to FIGS. 10A-10D, the inner plate 22″ and outer plate 24″ directly overlap. Unlike the prior embodiments, the inner plate 22″ is thinner compared to the outer plate 24″ such that it is flexible or elastic and can flex when attached to a band and includes additional features to facilitate attaching the clip 4C to a band 6. In this regard, a taper or bevel 36 is formed proximate to the free end 38 of the inner plate 22″ creating a ramped shoulder 40 on the inside surface 42 of the inner plate 22″ that abuts an outer edge 44 of the band 6 when the clip 4C is attached to a band 6. The shoulder facilitates placement of the clip 4C on a band 6 and resists removal of the clip 4C from the band 6 and, together with the inner surface 46 of the end wall 26″, engage the side edges 44 and 48 of the band 6.

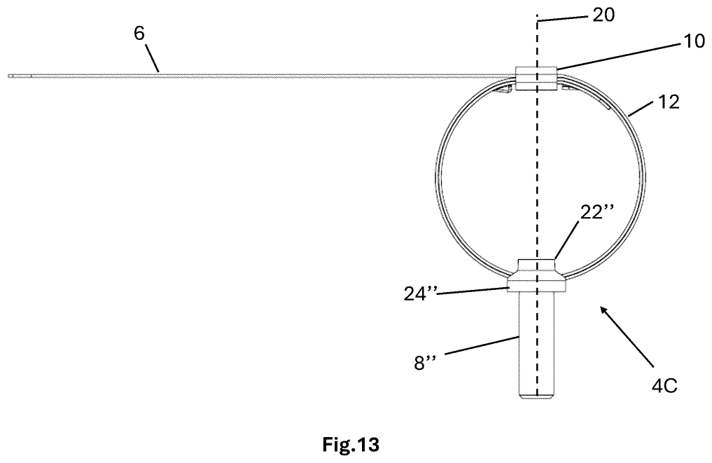

It is appreciated that in some embodiments, the aperture 30″ and the fastener 8″ may overlap with the inner plate 22″ such that the inner plate 22″, outer plate 24″ and fastener 8″ are linearly aligned as best seen in FIG. 13 with regard to clip 4C. Alternatively, FIG. 3 illustrates an embodiment of a clip 4A with a fastener 8 offset from the inner plate 22 along the longitudinal axis A_{Long Band} of the band 6. As illustrated in FIG. 6, the clip 4B illustrates an embodiment where the fastener 8′ is laterally offset from the longitudinal axis A_{Long Band} of the band 6. With regard to clips 4A and 4B, the extended area 50 and 50′ position the fasteners 8 and 8′ at different locations relative to the closed loop 12 of the band 6. It is contemplated and therefore within the scope of the present disclosure that the extended area 50 and 50′ may be of any shape or size and position a fastener 8 or 8′ at any needed location relative to the closed loop 12 of the band 6 to meet the physical requirements of an installation scenario.

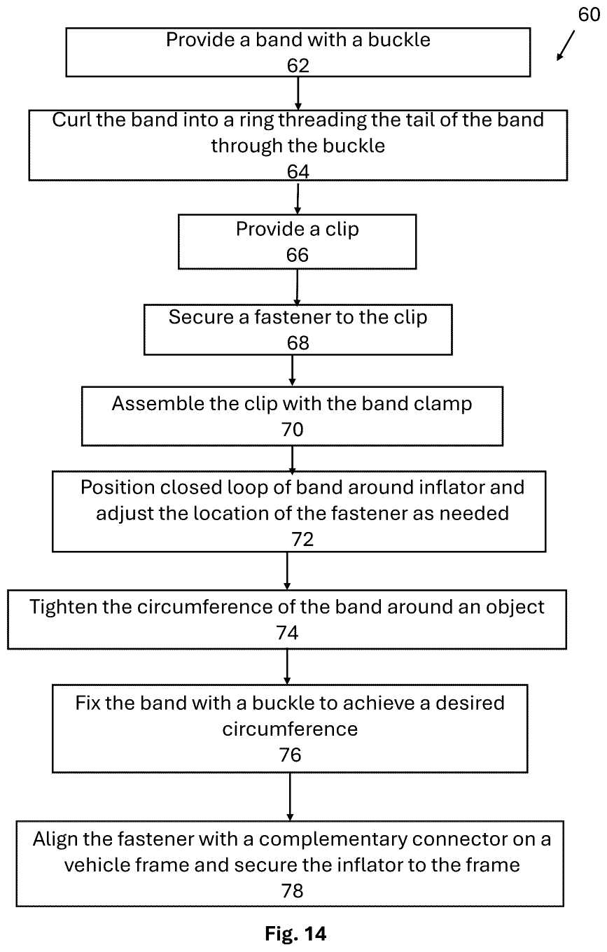

Referring now to FIG. 14, a method of installing a band clamp for inflators is described. In an initial step 62, a band clamp is provided. An installation technician then manually forms the band into a closed loop by threading the free end of the band though the buckle in a formation step 64. The loop is larger than the diameter of the inflator. In step 66, a clip of the type described herein is provided. In step 68, a fastener is secured to the clip. Alternatively, steps 66 and 68 may be reversed, e.g., the clip may be provided with the fastener previously attached. In step 70, the clip and fastener are connected to the closed loop of the band. As a further alternative, the clip with an attached fastener may be attached to the band as part of step 62 before the band is manually formed into a closed loop in step 64. As a further alternative, steps 62-70 may be automated with a clamp machine rather than manually performed. In step 72, the closed loop of the band is placed around an inflator and the location of the clip and fastener is changed, as needed, to locate the fastener in the desired location. In step 74, a tool is used to tighten the circumference of the band around the inflator or other object. In step 76, the band is locked relative to the buckle and thereby lock the position of the fastener. In step 78, the fastener is aligned with and secured to a complementary connector associated with a vehicle frame to secure the inflator to the vehicle frame.

As an alternative to the above process, the clip may be attached to the band after the closed loop is placed around the inflator but before the tool is used to tighten the circumference of the band. It should also be appreciated that one or more band clamps may be needed to secure an airbag initiator to the vehicle. Therefore, the foregoing steps would be repeated based upon the number of band clamps used. As a further alternative, the steps may be performed in multiple locations. For example, steps 62-76 may be completed at a first location, for example at a facility associated with an airbag inflator manufacturer. Step 78 may be performed at a vehicle assembly facility associated with a vehicle manufacturer.

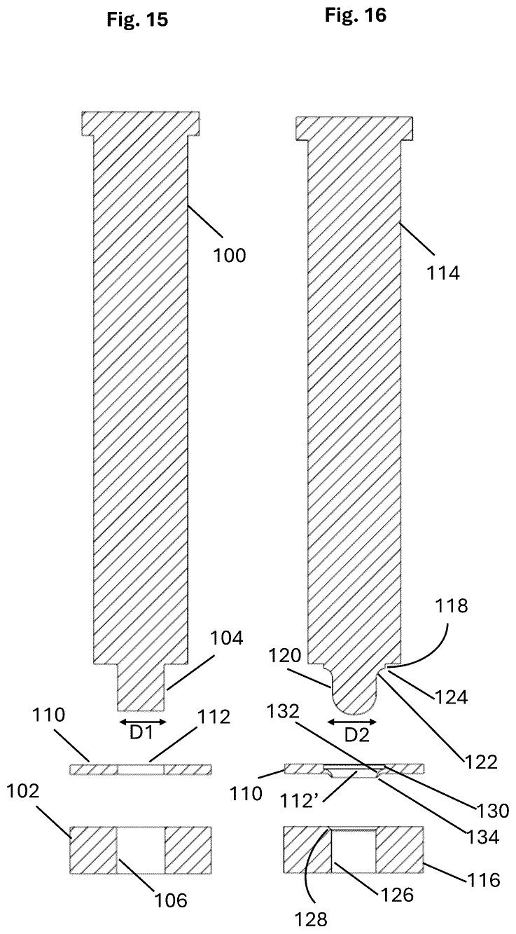

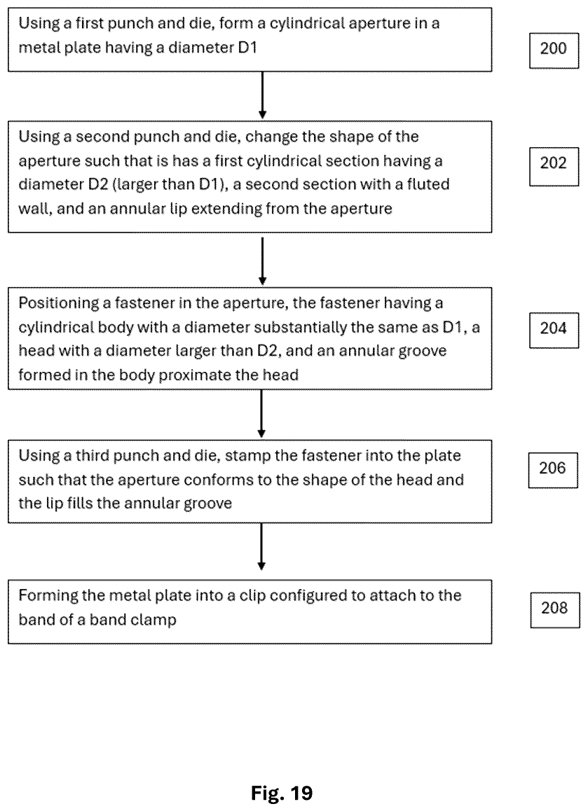

FIGS. 15-18A illustrate embodiments of progressive tools and dies for making a fastener and clip body, and the resulting clip and fastener, according to embodiments of the present disclosure. FIG. 19 illustrates a method of manufacturing a band clamp utilizing the progressive tools and dies of FIGS. 15-18A.

Turning to FIG. 15, a first tool 100 and first die 102 are shown in cross-section. The tool 100 and die 102 are part of a progressive manufacturing operation for forming an embodiment of a clip from a piece of metal plate to which a fastener will be secured. The tool 100 has a cylindrical tip or punch 104 having a first diameter D1 and the die 102 has a complimentary cylindrical aperture 106. Plate 110 includes a cylindrical aperture 112 formed by the operation of tool 100 and die 102. Plate 110 will be formed into a clip in a subsequent operation. The clip, with a fastener attached, will then be combined with a band clamp.

FIG. 16 illustrates a second tool 114 and die 116. The leading end of the tool 114 has a first cylindrical portion 118 that has a diameter D2 that is larger than D1 and a second cylindrical portion 120 that has a diameter the same as D1. A middle section 122 having a concave surface is positioned between the cylindrical sections 118 and 120 and forms a transition between the first and second sections 118 and 120. A shoulder 124, that is approximately ninety degrees, is created where the first cylindrical section 118 joins the middle section 122. The die 116 includes a cylindrical section 126 that compliments cylindrical section 120 of the tool 114. The die 116 also includes middle section 128. Following a punch operation using tool 114 and die 116, the aperture 112 in plate 110 is changed and now has a first cylindrical section 130 having a constant diameter D2 and a second section 132 having a concave or curved wall. The new aperture 112′ has an annular lip 134 has been formed in the plate 110 that extends outwardly around the perimeter of the aperture.

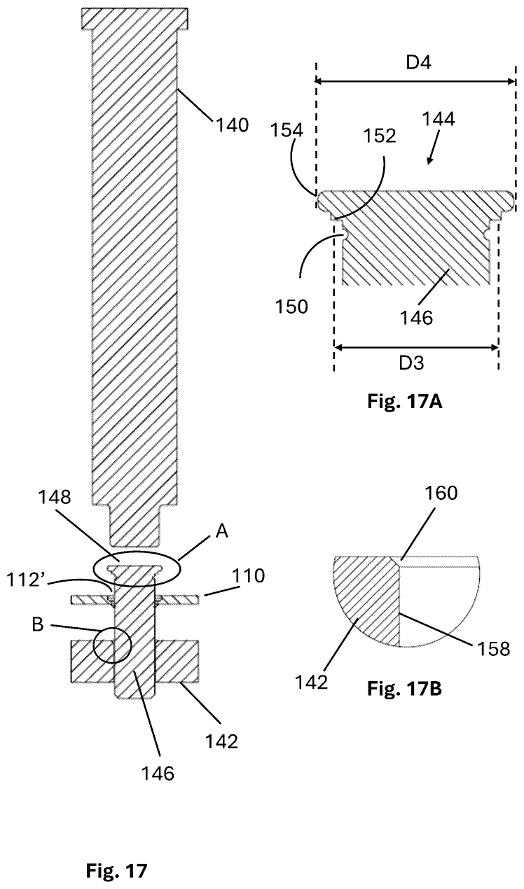

Turning to FIGS. 17, 17A and 17B, a further stage in the progressive operation is illustrated. In FIG. 17 a tool 140 and die 142 are shown with a fastener 144 and the plate 110 of FIG. 16. An enlarged partial portion of the fastener 144 is shown in FIG. 17A. The fastener has a cylindrical body 146 that is the same diameter D1 as the initial aperture formed by the punch 104 of tool 100. The fastener 144 has a head 148 that is wider than the diameter D2 of cylindrical portion 118 of tool 114. An annular groove 150 is formed in the cylindrical portion 146. The head 148 of the fastener includes a cylindrical section 152 having a diameter D2 and a second section 154 with a rounded outer surface 156 with a diameter larger than D2. The die 142 has a cylindrical aperture 158 having a diameter that is the same as the diameter of the cylindrical portion 146 of the fastener. In addition, as seen in FIG. 17B, the perimeter 160 of the leading portion of the aperture 158, is tapered outwardly.

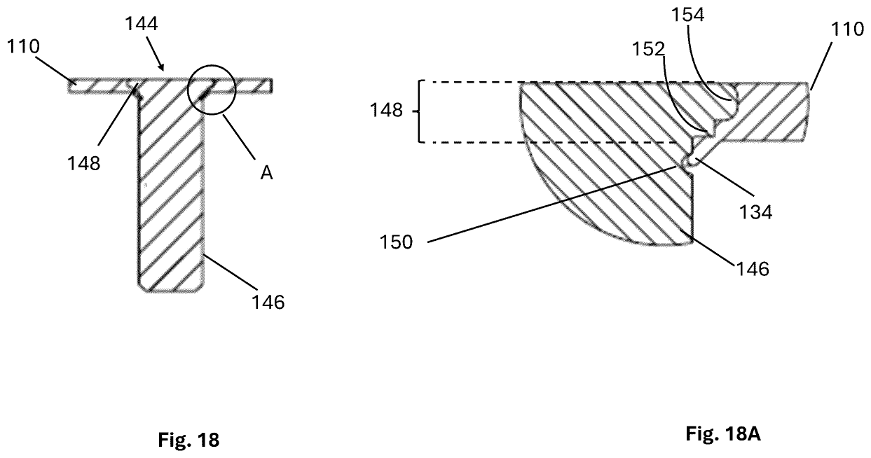

The tool 140 will press the fastener 144 into the plate 110. In accordance with at least one embodiment, the hardness of the plate 110 is equal to or greater than the hardness of the fastener 144. For example, the fastener 144 may preferably be zinc plated steel and the plate 110 a stainless steel or other metal having a comparable or greater hardness than the rated hardness of the fastener. As a result, tool 140 and the die 142 will cause the aperture 112′ of the plate 110 to conform to the shape of the head 148 of the fastener 144 and the tapered portion 160 of the die 142 will force the lip 134 to fill a portion of the annular groove 150. The result of the press operation is illustrated in FIGS. 18 and 18A.

Conventional wisdom involving clinch fasteners is for the fastener to have a hardness greater than the plate. In such a scenario, the fastener may not be securely held by the plate and could be loose within the aperture and susceptible to dislodging and falling out of the aperture during subsequent or downstream assembly steps. According to embodiments of the present disclosure, the progressive tool and die method described herein allows for the use of fasteners with a plate where the plate has a hardness either less than, comparable to or greater than the fastener. In this scenario, the plate material will conform to the shape of the fastener and thereby secure the fastener and the plate together without the addition of a nut or other securement device. This is particularly beneficial where, contrary to conventional wisdom, the plate hardness is higher than the rated hardness of the fastener. As described herein and in accordance with embodiments of the present disclosure, a fastener 144 may be secured to a plate 110 where the plate is subsequently formed into a clip as described and illustrated herein. The clip and fastener may then be attached to a band clamp and the band clamp positioned about a workpiece in a closed loop configuration. The clip and fastener may then be repositioned relative to the band to improve the ability of airbag installers to attach an airbag assembly. Throughout these various steps, the fastener could be dislodged from the plate or clip and thereby slow the assembly process.

A method of manufacturing a band clamp according to embodiments of the present disclosure is illustrated in FIG. 19. In a first step 200, a first punch and die is used to form a cylindrical aperture 112 in a metal plate 110. The aperture has a diameter D1.

In a second step 202, a second tool and die is used to change the shape of the aperture in the metal plate 110. Here, the new aperture 112′ will have a first cylindrical section 130 with a diameter D2, which is larger than D1, and a second section 132 with a concave side wall. In addition, the second tool and die cause an outwardly projecting lip 134 to be formed from the plate 110 surrounding the aperture 112′.

In a third step 204, a fastener 144 is placed in the aperture 112′. The body 146 of the fastener 144 extends out of the aperture 112′ where the lip 134 is located. The head 148 of the fastener 144 has a first cylindrical section 152 that has a diameter D3 that is greater than D2 and a second section 154 that has a diameter D4 that is greater than D3. In addition, the fastener has an annular groove 150 formed around the body 146 at a location proximate the head 148.

In a subsequent step 206, using a third tool and die, the fastener is pressed into the aperture 112′ of the metal plate 110. Because the metal plate is less hard, the side walls of the aperture conform to the shape of the fastener and at least a portion of the lip 134 fills at least a portion of the annular groove 150.

As noted previously, in a typical scenario, the fastener would be harder than the plate material. However, because in step 204, a chamfer or lip 134 is formed on the bottom of the plate 110 and in step 206 the die 142 also includes a chamfer 160, the plate may have a hardness greater than the fastener. Thus, according to embodiments of the present disclosure, any fastener/plate hardness combination within reason, may be successful.

In a further step 208, the metal plate is made into a clip of the kind described herein.

The concepts illustratively disclosed herein suitably may be practiced in the absence of any element which is not specifically disclosed herein. It is apparent to those skilled in the art, however, that many changes, variations, modifications, other uses, and applications of the disclosure are possible, and changes, variations, modifications, other uses, and applications which do not depart from the spirit and scope of the disclosure are deemed to be covered by the disclosure.

The foregoing discussion has been presented for purposes of illustration and description. The foregoing is not intended to limit the disclosure to the form or forms disclosed herein. Specifically, the features of a repositionable clip used in association with a band clamp are not limited to one type or style of band clamp. In the foregoing Detailed Description, for example, various features are grouped together in one or more embodiments for the purpose of streamlining the disclosure. The features of the embodiments may be combined in alternate embodiments other than those discussed above. This method of disclosure is not to be interpreted as reflecting an intention that the claims require more features than are expressly recited in each claim. Rather, as the following claims reflect, inventive aspects lie in less than all features of a single foregoing disclosed embodiment. Thus, the following claims are hereby incorporated into this Detailed Description, with each claim standing on its own as a separate embodiment.

Moreover, though the present disclosure has included description of one or more embodiments and certain variations and modifications, other variations, combinations, and modifications are within the scope of the disclosure, e.g., as may be within the skill and knowledge of those in the art, after understanding the present disclosure. It is intended to obtain rights which include alternative embodiments to the extent permitted, including alternate, interchangeable, and/or equivalent structures, functions, ranges, or steps to those claimed, regardless of whether such alternate, interchangeable, and/or equivalent structures, functions, ranges, or steps are disclosed herein, and without intending to publicly dedicate any patentable subject matter.

What is claimed is:

1. A clamping system comprising:
a band in the form of a closed loop;
a locking member affixed to the band;
a clip secured to the band and movable along the length of the band relative to the locking member; and
a fastener secured to the clip.

2. The system of claim 1, wherein the clip further comprises
an inner plate;
an outer plate spaced from the inner plate and defining a slot between the inner plate and outer plate;
wherein, the band is positioned in the slot.

3. The system of claim 2, wherein the inner plate has an inner surface with a beveled surface area.

4. The system of claim 2, wherein the inner plate and outer plate are joined and the clip is U-shaped.

5. The system of claim 2 wherein the band has a first side edge and a second side edge defining a width of the band; the fastener has first end and a second end defining a longitudinal axis of the fastener, and the longitudinal axis of the fastener would extend through the band between the first and second side edges.

6. The band of claim 5, wherein the closed loop formed by the band has a diameter and wherein the longitudinal axis of the fastener is coaxial with the diameter of the closed loop.

7. The band of claim 5, the closed loop formed by the band has a diameter and wherein the longitudinal axis of the fastener is not coaxial with the diameter of the closed loop.

8. The system of claim 2, wherein the inner plate has a first surface area and the outer plate has a second surface area that is larger than the first surface area of the inner plate, the fastener has first end and a second end defining a longitudinal axis of the fastener, and the fastener is affixed to the outer plate at a position where the longitudinal axis of the fastener would not extend through the first surface area of the inner plate.

9. The system of claim 8 wherein the band has a first side edge and a second side edge defining a width of the band, and the longitudinal axis of the fastener would not extend through the band between the first and second side edges.

10. The system of claim 8 wherein the band has a first side edge and a second side edge defining a width of the band, and the longitudinal axis of the fastener would extend through the band between the first and second side edges.

11. The system of claim 2, wherein the outer plate further comprises an extended area oriented perpendicular to a longitudinal axis of the band.

12. The system of claim 2, wherein the outer plate further comprises an extended area oriented parallel to a longitudinal axis of the band.

13. The system of claim 2, wherein the inner plate of the clip comprises a radiused end, and wherein the inner plate has a length substantially equal to a length of the outer plate.

14. The system of claim 1, wherein the fastener is a threaded fastener.

15. The system of claim 1, wherein the fastener is constructed with zinc plated carbon steel.

16. A method of installing a band clamp, comprising:
providing a band in the form of a closed loop;
attaching a fastener to the band within the closed loop wherein the position of the fastener is adjustable along the closed loop of the band;
positioning workpiece inside the loop;
reducing a circumference of the loop about the workpiece;
locking the band diameter with a locking member;
fixing the band clamp and workpiece to a structure using the fastener.

17. The method of claim 16, further comprising, prior to attaching a fastener to the band within the closed loop, forming a clip and attaching the fastener to the clip and wherein the step of attaching the fastener to the band comprises attaching the clip to the band.

18. The method of claim 17, wherein the step of attaching the fastener to the clip comprises swaging the clip to conform to the fastener.

19. The method of claim 18, wherein the step of swaging comprises using a tool and die to conform the clip about the fastener.

20. The method of claim 17, wherein the workpiece is an airbag inflator and the structure is a component of a vehicle.
